(19) United States
(12) Patent Application Publication
(10) Pub. No.: US 2018/0169939 A1
(43) Pub. Date: Jun. 21, 2018

(54) EXPOSURE DEVICE FOR AN APPARATUS FOR ADDITIVE MANUFACTURING OF THREE-DIMENSIONAL OBJECTS

(71) Applicant: CL SCHUTZRECHTSVERWALTUNGS GMBH, Lichtenfels (DE)

(72) Inventors: Jens Stammberger, Rõdental (DE); Tim Döhler, Großheirath (DE); Christian Diller, Lichtenfels (DE); Marie-Christin Ebert, Coburg (DE)

(73) Assignee: CL SCHULTZRECHTSVERWALTUNGS GMBH, Lichtenfels (DE)

(21) Appl. No.: 15/844,225

(22) Filed: Dec. 15, 2017

(30) Foreign Application Priority Data
Dec. 16, 2016 (DE) 102016124695.6

(51) Int. Cl. B29C 64/176; B22F 3/105; B29C 64/268; B29C 64/40

(52) U.S. Cl. CPC B29C 64/176; B22F 3/1055; B33Y 50/02; B29C 64/40; B29C 64/268

(57) ABSTRACT

Exposure device (1) for an apparatus (2) for additive manufacturing of three-dimensional objects (3) by progressive layer-by-layer selective exposure and, associated therewith, solidification of structural material layers composed of a solidifiable structural material (6) by means of an energy beam (5). The exposure device (1) comprises an energy beam generating device (4), a beam deflection device (7), and a beam path (9) formed by at least one optically conductive element or comprising at least one such element, and also a position detection device (13).

The invention relates to an exposure device for an apparatus for additive manufacturing of three-dimensional objects by progressive layer-by-layer selective exposure and, associated therewith, solidification of structural material layers composed of a solidifiable structural material by means of an energy beam, wherein the exposure device comprises an energy beam generating device configured for generating an energy beam, a beam deflection device configured for deflecting an energy beam generated by the energy beam generating device onto a specific incidence location, and a beam path formed by at least one optically conductive element or comprising at least one such element, wherein the energy beam generating device and the beam deflection device are optically coupled to one another via the beam path.

The use of corresponding exposure devices is fundamentally known in the field of additive manufacturing of three-dimensional objects.

What is of importance for a respective additive construction process is the exact positioning of the beam deflection devices associated with the exposure device, said beam deflection devices regularly also being referred to as scanner devices, relative to the construction plane. One challenge consists in ensuring the exact positioning of the beam deflection device relative to the construction plane even during the performance of additive construction processes. In particular, the heat that arises during the performance of additive construction processes can cause a certain expansion of diverse functional components, which can result in a change in the positioning of the beam deflection device relative to the construction plane.

In order to carry out possibly required corrections of the positioning of the beam deflection device or possibly of the entire exposure device, an exact knowledge of the current positioning of the beam deflection device is necessary.

The invention is based on the object of specifying an exposure device that is improved by comparison therewith, particularly with regard to an exact detection of a positioning of the beam deflection device.

The object is achieved by means of an exposure device according to claim 1. The dependent claims with respect thereto relate to possible embodiments of the exposure device.

The exposure device described herein constitutes a functional component of an apparatus for additive manufacturing of three-dimensional objects, i.e. in particular of technical components or technical component groups. A corresponding apparatus is also referred to hereinafter as an additive apparatus. As will become apparent hereinafter, such an apparatus can be an apparatus for performing selective laser sintering processes, i.e. an SLS apparatus, or an apparatus for performing selective laser melting processes, i.e. an SLM apparatus.

The exposure device comprises an energy beam generating device or such an energy beam generating device is assigned to the exposure device. The energy beam generating device or the components associated therewith can be present as a separate, if appropriate modular, assembly that can be connected to further assemblies of the exposure device. The energy beam generating device is configured for generating an energy beam, in particular a laser beam, for which purpose the energy beam generating device comprises corresponding energy or laser beam generating elements, for instance in the form of laser generators. The energy beam is used in the context of the performance of additive construction processes for selective exposure and, associated therewith, selective solidification of individual structural material layers composed of a correspondingly solidifiable, typically pulverulent, structural material.

The exposure device furthermore comprises a beam deflection device, which, as mentioned, is typically also referred to as a scanner device, or such a beam deflection device is assigned to the exposure device. The beam deflection device or the components associated therewith can also be present as a separate, if appropriate modular, assembly that can be connected to further assemblies of the exposure device. The beam deflection device is configured for deflecting an energy beam generated by the energy beam generating device onto a specific incidence location in a construction plane of an additive apparatus, for which purpose the beam deflection device comprises suitable beam deflection elements, for instance in the form of beam deflection mirrors, which are mounted movably in particular in at least one degree of freedom of movement. The beam deflection elements are typically arranged or embodied on or in a component of the beam deflection device, which component is typically also referred to as a scanning head.

The beam deflection device accordingly forms a coupling-out point for coupling out (optical) radiation from the exposure device. As will become apparent hereinafter, via the beam deflection device it is also possible, however, for radiation reflected e.g. from the construction plane, in particular from a fusion region generated by corresponding energy input in the construction plane, to be coupled into the exposure device. The beam deflection device accordingly also forms a coupling-in point for coupling (optical) radiation into the exposure device.

The exposure device furthermore comprises a beam path. The energy beam generating device and the beam deflection device are connected into the beam path and are optically coupled to one another via the beam path, such that e.g. an energy beam generated by the energy beam generating device can be coupled into the beam deflection device and can be coupled out via the latter in a manner known per se onto a specific incidence location within a construction plane of an additive apparatus.

The exposure device is distinguished by a position detection device and a measurement beam generating device that can be assigned or is assigned thereto. The position detection device and the measurement beam generating device can be combined structurally, i.e. e.g. in a common housing structure, and in this way, form a separate, if appropriate modular, assembly for detecting the position of the beam deflection device, which assembly can be connected to further assemblies of the exposure device.

The position detection device is configured for optically, i.e. in particular interferometrically, detecting the position of the beam deflection device, in particular relative to a reference position, by means of an optical measurement beam (“measurement beam”). By means of the position detection device, it is possible to exactly detect the position of the beam deflection device, in particular relative to a reference position, such as e.g. the construction plane of an additive apparatus. The detection of the position of the beam deflection device, which of course should also be understood to include an alignment of the beam deflection device, in particular relative to a reference alignment, is carried out optically, i.e. on the basis of the principles of interferometry, in particular laser interferometry, preferably absolute laser interferometry, which enables an absolute position to be detected. In this respect, the position detection device and the measurement beam generating device can form an absolute interferometer configured for detecting an absolute position of the beam deflection device.

The beam deflection device is configured, in particular, to deflect the measurement beam onto at least one optical measurement point (“measurement point”), in particular three optical measurement points, in particular (in each case) in the form of an optical element, preferably a concave mirror, which reflects the measurement beam. The position detection device is configured, in particular, to detect a position of the beam deflection device on the basis of that portion of the measurement beam which is reflected by the at least one measurement point. In this case, the detection of the position of the beam deflection device is carried out e.g. by way of the detection of a propagation time or a phase shift of the measurement beam, i.e. in particular of that portion of the measurement beam which is reflected back from a measurement point. It should be mentioned at this juncture that the measurement beam—as usual in the case of the abovementioned principles of laser interferometry—can typically comprise at least two different wavelengths. Furthermore, it should be mentioned that, in principle, the energy beam generating device can also serve or be embodied as a measurement beam generating device, such that in principle an energy beam generated by the energy beam generating device can also serve or be embodied as a measurement beam.

It goes without saying that diverse operating parameters of the exposure device, in particular of the beam deflection device, such as e.g. alignments, in particular angular positions, of individual or a plurality of beam deflection elements (e.g. relative to one another and/or relative to the construction plane of an additive apparatus), can be included in the detection of the position of the beam deflection device.

The measurement beam generating device is configured for generating the measurement beam used for optically, i.e. in particular interferometrically, detecting the position of the beam deflection device. What is essential here is that the measurement beam generated by the measurement beam generating device can be coupled or is coupled directly into the beam path of the exposure device. The position detection device or the measurement beam generating device is thus configured to couple the measurement beam directly into the beam path of the exposure device. The beam path of the exposure device is also used for the measurement beam. The measurement beam traverses the beam path from a measurement beam coupling-out point of the measurement beam generating device or of the position detection device and is coupled out from the exposure device via the coupling-out point of the exposure device by means of the beam deflection device. As mentioned, the beam deflection device is configured, in particular, to deflect the measurement beam onto at least one measurement point, in particular three measurement points, in particular in the form of an optical element, preferably a concave mirror, which reflects the measurement beam. A portion of the measurement beam that is reflected, e.g. by a measurement point, is coupled into the exposure device via the coupling-in point of the exposure device and traverses the beam path as far as a measurement beam coupling-in point of the measurement beam generating device or the position detection device.

Even though the measurement beam that can be generated or is generated by the measurement beam generating device can also be a laser beam, possibly generated by the energy beam generating device, the measurement beam differs from the energy beam that can be generated or is generated by the energy beam generating device typically in at least one beam parameter, in particular the energy intensity. Moreover, a coupling-out of an energy beam is typically carried out in a manner offset in time with respect to a coupling-out of a measurement beam; accordingly, the energy beam and the measurement beam are typically not coupled out from the exposure device simultaneously.

The exposure device can comprise a (further) detection device or a (further) detection device can be assigned to the exposure device. The (further) detection device is configured for detecting a reflected portion of the energy beam, said reflected portion arising in particular in a fusion region of a structural material layer that is to be solidified selectively or is solidified selectively. The reflected portion of the energy beam can be coupled or is coupled optically into the detection device via the beam path. The (further) detection device can be configured in terms of hardware and/or software to evaluate the detected reflected portion of the energy beam with regard to the quality, in particular the structural properties, of the object that is to be manufactured or is manufactured additively. The (further) detection device comprises suitable evaluation algorithms for this purpose. The background to this is that the reflected portion of the energy beam is dependent on diverse, in particular geometrical, parameters of the fusion region produced by corresponding energy input, said fusion region having a crucial effect on the component quality, i.e. in particular the structural properties, of the object that is to be manufactured or is manufactured additively.

Provided the exposure device comprises a corresponding detection device or such a detection device is assigned to said exposure device, the measurement beam generating device is configured, in particular, to couple the measurement beam into a section of the beam path that lies between the energy beam generating device and the (further) detection device. In this case, the measurement beam generating device is arranged or embodied between the energy beam generating device and the (further) detection device. It is conceivable, however, for the measurement beam generating device to be configured to couple the measurement beam into a section of the beam path that is disposed upstream of the detection device. In this case, the measurement beam generating device—at least when considering the coupling-out direction of the energy or measurement beam from the exposure device—is arranged or embodied upstream of the detection device.

A direct detection of the position of the beam deflection device in an exposure device is realized by means of the principle described. The principle described enables an exact detection of the position or an exact detection of alterations of the position of the beam deflection device. Consequently, an exposure device that is improved, in particular with regard to an exact detection of a positioning of the beam deflection device, is provided.

The position detection device is configured, in particular, to generate position detection information describing a detected position of the beam deflection device, in particular relative to a reference position. Corresponding position detection information can be used in terms of data by further functional components of an additive apparatus, in particular in association with the compensation or correction of (detected) position changes of the beam deflection device. By way of example, a control device of the additive apparatus, which is configured for controlling the selective exposure of a structural material layer, which exposure is to be carried out or is carried out by means of the exposure device, on the basis of exposure information describing the selective exposure of a respective structural material layer, can be configured to vary corresponding exposure information depending on position detection information generated by means of the position detection device, i.e. in particular to adapt said exposure information to a detected change in the position of the beam deflection device, in particular relative to a reference position.

As mentioned a number of times, the beam deflection device is typically configured to deflect the measurement beam onto at least one measurement point, in particular three measurement points, in particular in the form of an optical element, preferably a concave mirror, which reflects the measurement point, and the position detection device is configured to detect a position of the beam deflection device on the basis of the measurement beam reflected by the measurement point. In particular, an optical measurement point arrangement (“measurement point arrangement”), comprising a plurality of measurement points can be assignable or assigned to the exposure device. The measurement point arrangement can constitute a (functional) part of the position detection device. The measurement points associated with the measurement point arrangement are arranged or embodied in a defined spatial arrangement (in relative terms) with respect to one another. The measurement points can assume arbitrary spatial positions, in principle. The measurement points can be arranged or embodied in a common plane or else, if appropriate, in different spatial planes, as long as they are arranged or embodied in a defined spatial arrangement (in relative terms) with respect to one another. Each measurement point can serve for detecting specific position information of the beam deflection device. Consequently, the measurement beams reflected by respective measurement points can be used in each case for detecting specific position information of the beam deflection device. An absolute position of the beam deflection device, which absolute position is described by corresponding position detection information, can be generated from the individual items of position information by means of the position detection device.

As an alternative to the arrangement or embodiment of respective measurement points in different planes, it is also possible, of course, for the measurement points of a measurement point arrangement to be arranged or embodied in a common plane. The plane can be e.g. the construction plane of an additive apparatus. The measurement points can therefore in other words be arranged or embodied e.g. in particular within the construction plane, generally within a plane within the process chamber, of an additive apparatus. The measurement points can be arranged or embodied in a manner distributed equidistantly in the plane.

The invention furthermore relates to an apparatus (“additive apparatus”) for additive manufacturing of three-dimensional objects, i.e. for example technical components or technical component groups, by progressive layer-by-layer selective exposure and, associated therewith, solidification of structural material layers composed of a solidifiable structural material by means of an energy beam. Additive construction processes carried out by means of the apparatus are performed in a process chamber associated with the apparatus, which process chamber can typically be rendered inert. The process chamber can form part of a housing structure of the apparatus. The additive apparatus can be an SLM apparatus, i.e. an apparatus for carrying out selective laser melting methods (SLM methods), or an SLS apparatus, i.e. an apparatus for carrying out selective laser sintering methods (SLS methods). The selective solidification of respective structural material layers that are to be solidified selectively is carried out on the basis of object-related construction data. Corresponding construction data describe the geometric-structural shape of the object to be manufactured additively in each case and can include for example “sliced” CAD data of a respective object to be manufactured additively.

The additive apparatus comprises the functional components typically required for carrying out additive construction processes, i.e. in particular an exposure device for progressive layer-by-layer selective exposure and, associated therewith, solidification of structural material layers composed of a solidifiable structural material, i.e. in particular a particulate or pulverulent metal, plastic and/or ceramic material, and a coater device for forming structural material layers to be solidified in a construction plane. A construction plane can be a surface of a carrier element—typically mounted movably (in a vertical direction)—of a carrier device, or a structural material layer. In general, at least one structural material layer that is to be solidified selectively or is solidified selectively is arranged or embodied in a construction plane. The apparatus is distinguished by the fact that it comprises at least one exposure device as described. All explanations in connection with the exposure device described herein are accordingly analogously applicable to the additive apparatus.

The additive apparatus can comprise a control device for controlling the exposure of respective structural material layers, which exposure is to be carried out or is carried out by means of the exposure device, on the basis of exposure information describing the selective exposure of a respective structural material layer. The control device is configured to vary the exposure information depending on position detection information generated by means of the position detection device, i.e. in particular to adapt said exposure information to a detected change in the position of the beam deflection device, in particular relative to a reference position. Corresponding position detection information, as mentioned, can accordingly be used in terms of data by further functional components of an additive apparatus, i.e. in particular a corresponding control device for compensation or correction of (detected) position changes of the beam deflection device. In concrete terms this can be implemented e.g. in such a way that in the event of a detected position change of the beam deflection device in a specific spatial direction by a specific amount, i.e. e.g. 0.2 mm, a corresponding adaptation of the exposure is performed, such that the energy beam is directed onto the structural material layer in a manner offset by the corresponding amount in the corresponding spatial direction.

Finally, it should be noted that the beam deflection device can also be configured to direct the optical measurement beam onto a structural material layer to be solidified selectively, and the position detection device, in particular in the function of a layer thickness detection device, can be configured to detect (directly) the layer thickness of the structural material layer on the basis of that portion of the optical measurement beam that is reflected by the structural material layer. In this way, a layer thickness detection device can additionally be implemented in a simple manner.

The invention furthermore relates to a method for optically, in particular interferometrically, detecting the position of the beam deflection device, in particular relative to a reference position, of an exposure device comprising a beam path, in particular an exposure device as described, of an additive apparatus by means of an optical measurement beam. The method is distinguished by the following steps: generating an optical measurement beam, optically, in particular interferometrically, detecting the position of the beam deflection device, in particular relative to a reference position, by means of the optical measurement beam, in particular by means of a portion of the optical measurement beam that is reflected by a measurement point. According to the method, the optical measurement beam is coupled directly into the beam path of the exposure device. All explanations in connection with the exposure device described herein are accordingly also analogously applicable to the method. Conversely, all explanations in connection with the method are analogously applicable to the exposure device and the additive apparatus.

According to the method, the measurement beam thus traverses the beam path of the exposure device, in particular of a measurement beam generating device or position detection device associated with the exposure device, and is coupled out from the exposure device via a coupling-out point of the exposure device by means of the beam deflection device. The beam deflection device directs the measurement beam onto at least one measurement point, in particular in the form of an optical element, preferably a concave mirror, which reflects the measurement beam. That portion of the measurement beam which is reflected by a measurement point is coupled into the exposure device (again) via a coupling-in point of the exposure device and traverses the beam path as far as a position detection device. The position detection device detects the position of the beam deflection device on the basis of the reflected portion of the measurement beam, i.e. e.g. by way of the propagation time or phase shift thereof. The coupling-out of the measurement beam is typically carried out in a manner offset in time with respect to a coupling-out of an energy beam; energy beam and measurement beam are accordingly typically not coupled out simultaneously. Consequently, exposure and position detection processes are typically performed in an alternating fashion; in particular, a position detection process can be carried out after an exposure process of a (first) structural material layer or before an exposure process of a further structural material layer to be exposed subsequently.

The invention is explained in greater detail on the basis of exemplary embodiments in the figures of the drawings, in which:

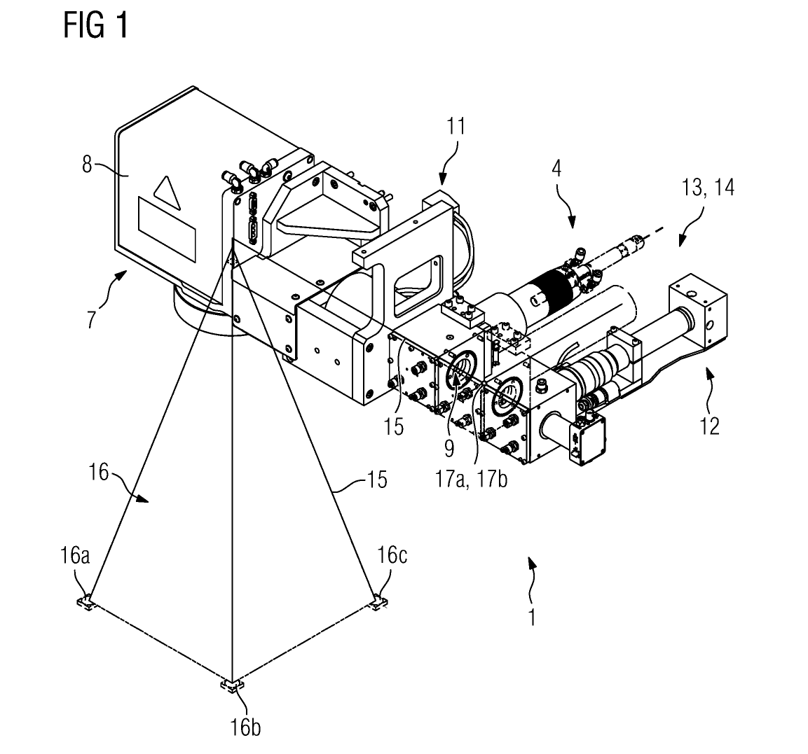

FIG. 1 shows a basic illustration of an exposure device in accordance with one exemplary embodiment; and

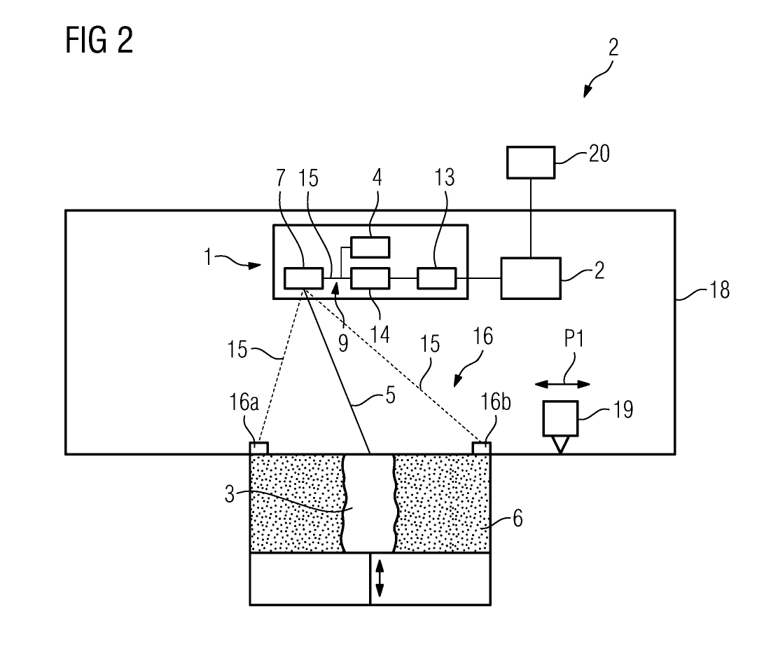

FIG. 2 shows a basic illustration of an apparatus in accordance with one exemplary embodiment.

FIG. 1 shows a basic illustration of an exposure device 1 in accordance with one exemplary embodiment. The exposure device 1 is shown in a perspective view in FIG. 1.

The exposure device 1 constitutes a functional component of an apparatus 2 for additive manufacturing of three-dimensional objects 3, i.e. in particular technical components or technical component groups. A corresponding apparatus 2 can be an apparatus for carrying out selective laser sintering processes, i.e. an SLS apparatus, or an apparatus for carrying out selective laser melting processes, i.e. an SLM apparatus. One exemplary embodiment of a corresponding apparatus 2 in the form of an SLM apparatus is shown in FIG. 2.

The exposure device 1 comprises an energy beam generating device 4. The energy beam generating device 4 or the components associated therewith can be present as a separate, if appropriate modular, assembly (not designated in more specific detail) that can be connected to further assemblies of the exposure device 1. The energy beam generating device 4 is configured for generating an energy beam 5, in particular a laser beam. For this purpose, the energy beam generating device 4 comprises corresponding energy or laser beam generating elements (not shown), for instance in the form of laser generators. The energy beam 5 is used in the context of the performance of additive construction processes for selective exposure and, associated therewith, selective solidification of individual structural material layers composed of a correspondingly solidifiable, typically pulverulent, construction material 6 (cf. FIG. 2).

The exposure device 1 furthermore comprises a beam deflection device 7, also to be designated as a scanner device. The beam deflection device 7 or the components associated therewith can also be present as a separate, if appropriate modular, assembly that can be connected to further assemblies of the exposure device 1. The beam deflection device 7 is configured for deflecting an energy beam 5 generated by the energy beam generating device 4 onto a specific incidence location in a construction plane of an additive apparatus. For this purpose, the beam deflection device 7 comprises suitable beam deflection elements (not designated in more specific detail), for instance in the form of beam deflection mirrors, which are mounted movably in particular in at least one degree of freedom of movement. The beam deflection elements are typically arranged or embodied on or in a component 8 of the beam deflection device 7, said component typically also being referred to as a scanner head.

The beam deflection device 7 forms a coupling-out point for coupling out (optical) radiation from the exposure device 1. By means of the beam deflection device 7, however, it is also possible for radiation that is reflected, e.g. from the construction plane, in particular from a fusion region produced by corresponding energy input in the construction plane, to be coupled into the exposure device 1. The beam deflection device 7 accordingly also forms a coupling-in point for coupling (optical) radiation into the exposure device 1.

The exposure device 1 furthermore comprises an (optical) beam path 9. As is evident, the energy beam generating device 4 and the beam deflection device 7 are connected into the beam path 9 and optically coupled to one another via the beam path 9, such that e.g. an energy beam 5 generated by the energy beam generating device 7 can be coupled into the beam deflection device 7 and can be coupled out via the latter onto a specific incidence location within a construction plane of an additive apparatus.

In the exemplary embodiment shown in FIG. 1, further optional functional components of the exposure device 1 are connected into the beam path 9 of the exposure device 1. They include a focusing device 11 and a detection device 12. The focusing device 11 is configured for setting the focus of the energy beam 5 and for this purpose comprises a plurality of optical focusing elements (not shown), in particular lens elements, which are mounted movably in particular relative to one another. The detection device 12 is configured for detecting a reflected portion of the energy beam 5, said reflected portion arising in particular in a fusion region of a structural material layer that is to be solidified selectively or is solidified selectively. The reflected portion of the energy beam 5 can be coupled optically into the detection device via the beam path 9. The detection device 12 is configured in terms of hardware and/or software to evaluate the detected reflected portion of the energy beam 5 with regard to the quality, i.e. in particular the structural properties, of the object 3 that is to be manufactured or is manufactured additively, and comprises suitable evaluation algorithms for this purpose.

The exposure device 1 furthermore comprises a position detection device 13 and a measurement beam generating device 14 assigned thereto. In the exemplary embodiment shown, the position detection device 13 and the measurement beam generating device 14 are structurally combined in a common housing structure (not designated) and in this way form a separate, if appropriate modular, assembly that can be connected to further assemblies of the exposure device 1.

The position detection device 13 is configured for optically, i.e. in particular interferometrically, detecting the position of the beam deflection device 7, in particular relative to a reference position, by means of an optical measurement beam 15. By means of the position detection device 13, it is possible to exactly detect the position of the beam deflection device 7, in particular relative to a reference position, such as e.g. the construction plane of an additive apparatus 2. The detection of the position of the beam deflection device 7, which should also be understood to include an alignment of the beam deflection device 7, in particular relative to a reference alignment, is carried out optically, i.e. on the basis of the principles of interferometry, in particular laser interferometry or absolute laser interferometry. The beam deflection device 7 is configured to deflect the measurement beam 15 onto an optical measurement point 16a-16c in the form of an optical element, preferably a concave mirror, which reflects the measurement beam 15. The position detection device 13 is configured to detect a position of the beam deflection device 7 on the basis of that portion of the measurement beam 15 which is reflected by the measurement point(s) 16a-16c. In this case, the detection of the position of the beam deflection device 7 takes place by way of the detection of the propagation time or the phase shift of the measurement beam 15, i.e. in particular of that portion of the measurement beam 15 which is reflected back from a measurement point 16a-16c. The measurement beam 15 typically comprises at least two different wavelengths.

It goes without saying that diverse operating parameters of the exposure device 1, in particular of the beam deflection device 7, such as e.g. alignments, in particular angular positions, of individual or a plurality of beam deflection elements (e.g. relative to one another and/or relative to the construction plane), can be included in the detection of the position of the beam deflection device 7.

The measurement beam generating device 14 is configured for generating the measurement beam 15. The position detection device 13 and the measurement beam generating device 14 can form an absolute interferometer. What is essential is that the measurement beam generating device 14 is configured to couple the measurement beam 15 directly into the beam path 9 of the exposure device 1, that is to say that the measurement beam 15 can be coupled or is coupled directly into the beam path 9 of the exposure device 1. The measurement beam generating device 14 is accordingly configured to couple the measurement beam 15 directly into the beam path 9 of the exposure device 1. The measurement beam 15 traverses the beam path 9 from a measurement beam coupling-out point 17b of the measurement beam generating device 14, is deflected if appropriate via optical deflection elements (not shown), such as mirror elements, and is coupled out from the exposure device 1 via the coupling-out point of the exposure device 1 by means of the beam deflection device 7. A portion of the measurement beam 15 that is reflected by a measurement point 16a-16c is coupled into the exposure device 1 via the coupling-in point of the exposure device 1 and traverses the beam path 9 as far as a measurement beam coupling-in point 17a of the position detection device 13. It is evident that the measurement beam coupling-in point 17a and the measurement beam coupling-out point 17b can coincide.

In the exemplary embodiment shown, the measurement beam generating device 14 is configured to couple the measurement beam 15 into a section of the beam path 9 that lies between the energy beam generating device 4 and the detection device 12, and is correspondingly arranged or embodied between the energy beam generating device 4 and the detection device 12. However, it would also be conceivable to couple the measurement beam 15 into a section of the beam path 9 that is disposed upstream of the detection device 12. In this case, the measurement beam generating device 14—at least when considering the coupling-out direction of the energy or measurement beam 15 from the exposure device 1—would be arranged upstream of the detection device 12.

Just like the energy beam 5, the measurement beam 15 can be a laser beam. However, the measurement beam 15 differs from the energy beam 5 typically in at least one beam parameter, in particular the energy intensity. Moreover, a coupling-out of the energy beam 5 is typically carried out in a manner offset in time with respect to a coupling-out of the measurement beam 15; accordingly, the energy beam 5 and the measurement beam 15 are typically not coupled out from the exposure device 1 simultaneously.

The position detection device 13 is configured to generate position detection information describing a detected position of the beam deflection device 7, in particular relative to a reference position. Corresponding position detection information, as explained further below in association with the description of the exemplary embodiment in accordance with FIG. 2, can be used in terms of data by further functional components of an additive apparatus 2, in particular in connection with the compensation or correction of (detected) position changes of the beam deflection device.

With reference to FIG. 1 it is evident that an optical measurement point arrangement 16 comprising a plurality of measurement points 16a-16c is assigned to the exposure device 1. The measurement point arrangement 16 constitutes a (functional) part of the position detection device 13. The measurement points 16a-16c associated with the measurement point arrangement 16 are arranged in a defined spatial arrangement (in relative terms) with respect to one another. In the exemplary embodiment shown in FIG. 1, the measurement points 16a-16c are arranged in a common plane, which can be the construction plane of an additive apparatus. Each measurement point 16a-16c can serve for detecting specific position information of the beam deflection device 7. Consequently, the measurement beams 15 or measurement beam portions reflected by respective measurement points 16a-16c can be used in each case for detecting specific position information of the beam deflection device 7. The position detection device 13 can generate an absolute position of the beam deflection device 7, said absolute position being described by corresponding position detection information, from the individual items of position information.

FIG. 2 shows a basic illustration of an apparatus 2 in accordance with one exemplary embodiment. The apparatus 2 is illustrated in a purely schematic view in FIG. 2.

The apparatus 2 serves for additive manufacturing of three-dimensional objects 3, i.e. for example technical components or technical component groups, by progressive layer-by-layer selective exposure and, associated therewith, solidification of structural material layers composed of a solidifiable structural material 6 by means of an energy beam 5 generated by an energy beam generating device 4. The apparatus 2 is an SLM apparatus, i.e. an apparatus for carrying out selective laser melting methods (SLM methods). The energy beam 5 is accordingly a laser beam, and the structural material 6 is, in particular, a particulate or pulverulent metal, such as e.g. aluminium, high-grade steel or titanium. The selective solidification of respective structural material layers to be solidified is carried out on the basis of object-related construction data. Corresponding construction data describe the geometric or geometric-structural shape of the object 3 that is to be manufactured additively in each case. Corresponding construction data can include for example “sliced” CAD data of the object 3 to be manufactured.

The apparatus 2 comprises a process chamber 18, which can be rendered inert. The process chamber 18 can form part of a housing structure (not designated in more specific detail) of the apparatus 2. In the process chamber 18, there are arranged or embodied the functional components required for carrying out additive construction processes, i.e. in particular the exposure device 1 and a coater device 19, mounted movably, as indicated by the horizontally aligned double-headed arrow P1, for forming structural material layers to be solidified in a construction plane.

The apparatus 2 comprises an exposure device 1 as described in connection with the exemplary embodiment shown in FIG. 1. The exposure device 1 is illustrated without the focusing device 11 and without the detection device 12, in order to clarify that, in principle, they are optional functional components of the exposure device 1. The energy beam 5 generated by means of the energy beam generating device 4 is illustrated in a solid fashion; the measurement beam 15 generated by means of the energy beam generating device 14 is illustrated in a dashed fashion. As mentioned, a coupling-out of the energy beam 5 is typically carried out in a manner offset in time with respect to a coupling-out of the measurement beam 15; accordingly, the energy beam 5 and the measurement beam 15 are typically not coupled out from the exposure device 1 simultaneously.

The apparatus 2 comprises a control device 20 implemented in terms of hardware and/or software. The control device 20 is configured for controlling the exposure of respective structural material layers, which exposure is to be carried out or is carried out by means of the exposure device 1, on the basis of exposure information describing the selective exposure of a respective structural material layer. The control device 20 is configured to vary the exposure information depending on position detection information generated by means of the position detection device 13, in particular to adapt said exposure information to a detected change in the position of the beam deflection device 7, in particular relative to a reference position. Accordingly, corresponding position detection information can be used in terms of data by further functional components of an additive apparatus 2, i.e. in particular the control device 20 for compensation or correction of (detected) position changes of the beam deflection device 7. In concrete terms this can be implemented e.g. in such a way that in the event of a detected position change of the beam deflection device 7 in a specific spatial direction by a specific amount, i.e. e.g. 0.2 mm, a corresponding adaptation of the exposure is carried out, such that the energy beam 5 is directed onto the structural material layer to be solidified selectively in a manner offset by the corresponding amount in the corresponding spatial direction.

The beam deflection device 7 can be configured to direct the optical measurement beam 15 onto a structural material layer that is to be solidified selectively. The position detection device 13, in particular in the function of a layer thickness detection device, can be configured to detect (directly) the layer thickness of the structural material layer on the basis of that portion of the optical measurement beam 15 which is reflected by the structural material layer.

With the exposure device 1 or the apparatus 2 it is possible to implement a method for optically, in particular interferometrically, detecting the position of the beam deflection device 7, in particular relative to a reference position, of a corresponding exposure device 1 by means of a measurement beam 15. The method is distinguished by the following steps: generating an optical measurement beam 15, optically detecting, in particular by (absolute) interferometry, the position of the beam deflection device 7, in particular relative to a reference position, by means of the optical measurement beam 15, in particular by means of a portion of the optical measurement beam 15 that is reflected by a measurement point 16a-16c. According to the method, the optical measurement beam 15 is coupled directly into the beam path 9 of the exposure device 1.

1. Exposure device (1) for an apparatus (2) for additive manufacturing of three-dimensional objects (3) by progressive layer-by-layer selective exposure and, associated therewith, solidification of structural material layers composed of a solidifiable structural material (6) by means of an energy beam (5), wherein the exposure device (1) comprises an energy beam generating device (4) configured for generating an energy beam (5), a beam deflection device (7) configured for deflecting an energy beam (5) generated by the energy beam generating device (4) onto a specific incidence location, and a beam path (9) formed by at least one optically conductive element or comprising at least one such element,
characterized by a position detection device (13) configured for optically, in particular interferometrically, detecting the position of the beam deflection device (7), in particular relative to a reference position, by means of an optical measurement beam (15), and by
a measurement beam generating device (14), which is assigned to the position detection device (13) which is configured for generating the optical measurement beam (15) used for optically detecting the position of the beam deflection device (7), wherein the optical measurement beam (15) generated by the measurement beam generating device (14) can be coupled or is coupled directly into the beam path (9) of the exposure device (1).

2. Exposure device according to claim 1, characterized in that the energy beam generating device (4) and the beam deflection device (7) are optically coupled to one another via the beam path (9).

3. Exposure device according to claim 1, characterized in that the position detection device (13) and the measurement beam generating device (14) form an absolute interferometer.

4. Exposure device according to claim 1, characterized in that the position detection device (13) is configured to generate position detection information describing a detected position of the beam deflection device (7), in particular relative to a reference position.

5. Exposure device according to claim 1, characterized in that the beam deflection device (7) is configured to direct the optical measurement beam (15) onto at least one optical measurement point (16a-16c), in particular three optical measurement points (16a-16c), in particular in the form of an optical element, preferably a concave mirror, which reflects the optical measurement beam (15), and the position detection device (13) is configured to detect a position of the beam deflection device (7) on the basis of that portion of the optical measurement beam (15) which is reflected by the at least one optical measurement point (16a-16c).

6. Exposure device according to claim 5, characterized by an optical measurement point arrangement (16) comprising a plurality of optical measurement points (16a-16c), wherein the optical measurement points (16a-16c) associated with the optical measurement point arrangement (16) are arranged or embodied in a defined spatial arrangement with respect to one another.

7. Exposure device according to claim 6, characterized in that the optical measurement points (16a-16c) associated with the optical measurement point arrangement (16) are arranged or embodied in a common plane, in particular within a structural plane of an apparatus (2) for additive manufacturing of three-dimensional objects (3), or at least two of the optical measurement points (16a-16c) associated with the optical measurement point arrangement (16) are arranged or embodied in different planes.

8. Exposure device according to claim 1, characterized by a detection device (12) configured for detecting a reflected portion of the energy beam (5), said reflected portion arising in particular in a fusion region of a structural material layer that is to be solidified selectively or is solidified selectively, wherein the reflected portion of the energy beam (5) can be coupled or is coupled optically into the detection device (12) via the beam path (9) of the exposure device (1), wherein the detection device (12) is configured to generate component quality information, describing the component quality of a three-dimensional object (3) that is to be manufactured or is manufactured additively, on the basis of the reflected portion of the energy beam (5) coupled optically into the detection device (12) via the beam path (9) of the exposure device (1).

9. Exposure device according to claim 8, characterized in that the measurement beam generating device (14) is configured to couple the optical measurement beam (15) into a section of the beam path (9) of the exposure device (1) that lies between the energy beam generating device (4) and the detection device (12), or the measurement beam generating device (14) is configured to couple the measurement beam (15) into a section of the beam path (9) of the exposure device (1) that is disposed upstream of the detection device (12).

10. Apparatus (2) for additive manufacturing of three-dimensional objects (3) by progressive layer-by-layer selective exposure and, associated therewith, solidification of structural material layers composed of a solidifiable structural material (6) by means of energy beam (5), characterized in that the apparatus (2) comprises an exposure device (1) according to claim 1.

11. Apparatus according to claim 10, characterized by a control device for controlling the exposure of respective structural material layers, which exposure is to be carried out or is carried out by means of the exposure device (1), on the basis of exposure information describing the selective exposure of a respective structural material layer, wherein the control device is configured to vary the exposure information depending on position detection information generated by means of the position detection device (13), in particular to adapt said exposure information to a detected change in the position of the beam deflection device (7), in particular relative to a reference position.

12. Apparatus according to claim 1, characterized in that the energy beam generating device (4) is additionally embodied as a measurement beam generating device (14), wherein an energy beam (5) generated by the energy beam generating device (4) is embodied as a measurement beam (15).

13. Apparatus according to claim 1, characterized in that the beam deflection device (7) is configured to direct the optical measurement beam (15) onto a structural material layer to be solidified, and the position detection device (13) is configured to detect the layer thickness of the structural material layer on the basis of that portion of the optical measurement beam (15) which is reflected by the structural material layer.

14. Method for optically, in particular interferometrically, detecting the position of a beam deflection device (7) of an exposure device (1) comprising a beam path (9), in particular of an exposure device (1) according to claim 1, of an apparatus (2) for additive manufacturing of three-dimensional objects (3) by progressive layer-by-layer selective exposure and, associated therewith, solidification of structural material layers composed of a solidifiable structural material (6) by means of an energy beam (5), in particular relative to a reference position, by means of an optical measurement beam (15), characterized by the following steps:
generating an optical measurement beam (15),
optically, in particular interferometrically, detecting the position of the beam deflection device (7), in particular relative to a reference position, by means of the optical measurement beam (15), in particular by means of a portion of the optical measurement beam (15) that is reflected by at least one measurement point (16a-16c),
wherein the optical measurement beam (15) can be coupled or is coupled directly into the beam path (9) of the exposure device (1).
